(19) United States
(12) Patent Application Publication
(10) Pub. No.: US 2023/0214901 A1
(43) Pub. Date: Jul. 6, 2023

(54) SYSTEM AND METHOD TO RECOMMEND CLOUD SERVICE

(71) Applicant: SAP SE, Walldorf (DE)

(72) Inventors: Sreenivasulu Gelle, San Ramon, CA (US); Alexander Ocher, San Jose, CA (US)

(21) Appl. No.: 17/569,624

(22) Filed: Jan. 6, 2022

(51) Int. Cl. G06Q 30/06; G06Q 30/02

(52) U.S. Cl. CPC G06Q 30/0631; G06Q 30/0202

(57) ABSTRACT

Some embodiments include a system, method, and non-transitory medium, with the method including receiving, from a user, values for a set of usage-related parameters for one or more cloud services; determining, based on historical time series data for the one or more services provided by at least one cloud service provider, a predicted trend of future values for the set of usage-related parameters for the one or more cloud services for the at least one cloud service provider; evaluating the predicted trend of future values for the set of usage-related parameters for the one or more cloud services for each of the at least one cloud service providers to generate a recommendation that best corresponds, at least within a specified threshold, to the values for the set of usage-related parameters received from the user; and storing an indication of the generated recommendation in a data storage device.

### BACKGROUND

An individual, organization, or enterprise may currently use or desire to use one or more cloud services (e.g., infrastructure, platforms, or software) that are hosted by third-party providers or suppliers. The cloud services are typically made available to users through the Internet.

Many types of cloud services are provided by many different cloud service suppliers. The number and variety of cloud services continues to grow and evolve. A critical parameter that might be considered by many customers when choosing a cloud service is the value the cloud service will provide them based on their current and future needs. As such, it may not be sufficient to know the cloud service's value now when it is acquired. It might be even more important to predict how this value compares to other products over time, since the adaptation of a new cloud service might be a costly undertaking for an individual or organization. Given there are many cloud services available in the marketplace and selecting a suitable cloud service can be a multi-step process that grows more complex as new services emerge, cloud service customers have traditionally often made their choice of a cloud service without having full factual information. Accordingly, the selection of cloud services has often not resulted in an optimal choice for the customer.

Accordingly, it would therefore be desirable to provide a recommendation of a wide variety of cloud services in an efficient and data-driven manner.

### BRIEF DESCRIPTION OF THE DRAWINGS

FIG. 1 is an illustrative example of a high level architecture for a cloud service recommendation system, according to some embodiments;

FIG. 2 is an illustrative depiction of a table associated with a cloud service recommendation system, according to some embodiments;

FIG. 3 is an illustrative depiction of a table for cloud services, according to some embodiments;

FIG. 4 is an illustrative depiction of a table for cloud service attributes, according to some embodiments;

FIG. 5 is an illustrative flow diagram for a process, according to some embodiments;

FIG. 6 is an outward facing user interface related to a system and process for a cloud service recommendation, according to some embodiments; and

FIG. 7 is an example of a computer system useful for implementing various embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and convenience.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

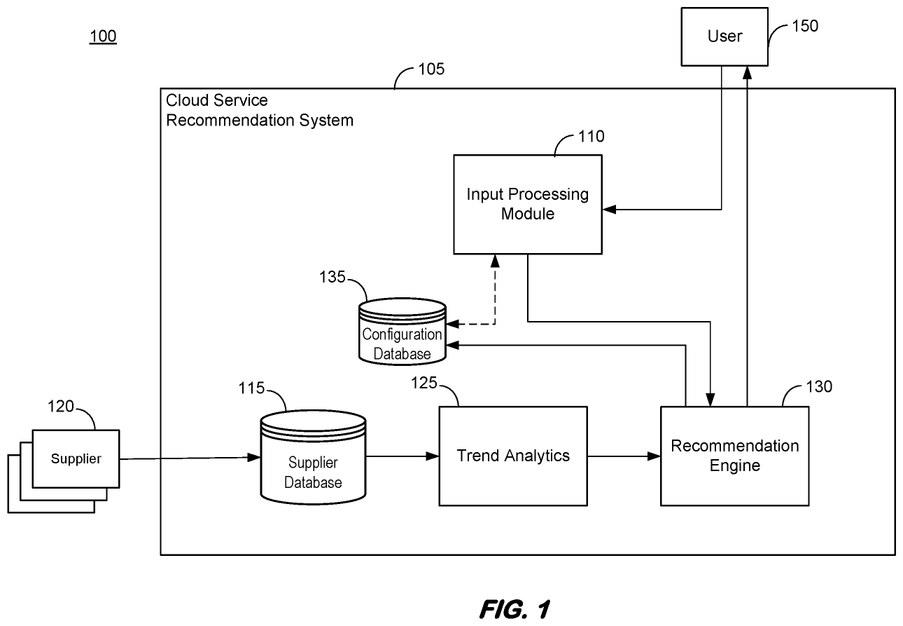

Provided herein are system, method and/or computer program product embodiments, and/or combinations and sub-combinations thereof, to provide and support a recommendation for a cloud service based on one or more (i.e., a set) requirements for a user entity (e.g., organization, business owner, etc.), where the recommendation is determined based on present and future data-driven requirements and restraints for the user entity. For example, FIG. 1 is an illustrative example of a high level cloud architecture 100 for a cloud service recommendation system 105 according to some embodiments. In some embodiments, architecture 100 might represent aspects of a cloud-based distributed computing environment where cloud service recommendation system 105 might be implemented by a combination of hardware components (devices, systems, etc.) and software components (executable applications, routines, instructions, services, etc.) deployed on one or more nodes, pods, or clusters of cloud-based computing resources. In some embodiments, user 150 may provide information including their current and future, prospective use of a cloud service to input processing module 110 of the cloud service recommendation system. In some aspects, the cloud service usage-related information received from the user includes one or more values for usage-related parameters for a cloud service. In some aspects, the usage-related parameters and their associated values are provided by the user as input parameters to input processing module 110. In some instances, the usage-related parameters might include the requirements for a cloud service to meet the user's expected (i.e., prospective) or otherwise desired operating needs. In some embodiments, the values for the usage-related parameters for a cloud service from the user might be based on current or present (i.e., actual) use of a cloud service by the user. In some embodiments, the values for the usage-related parameters for a cloud service from the user might be based on envisioned, future need(s) for a cloud service by the user.

In some embodiments, a maximum value of available payment tokens, price points, and other forms of payment and currency may be specified as part of the input parameters from the user. In some instances, the maximum value of available payment tokens, price points, and other forms of payment and currency specified by the user might be used as an overall constraint in determining a recommended cloud service. For example, the user to might be asked (or optionally required) to specify a maximum amount of payment tokens (e.g., an amount of a cryptocurrency) that the user is willing to pay for these cloud services.

As further illustrated in FIG. 1, cloud service recommendation system 105 includes a supplier database 115. In some embodiments, supplier database 115 might be provided by a DBMS (database management system) application or service. In some aspects, historical information regarding cloud services provided by one or more suppliers 120 might be retrieved from or obtained from the suppliers. The historical information may include operating specifications for the one or more services supported and provided by the suppliers. As used herein, suppliers 120 might include a cloud provider that delivers cloud computing based services to organizations and individuals. Suppliers 120 might provide provider-managed virtual hardware, software, infrastructure and other related services to, for example, user 150. Services and solutions provided by some of suppliers 120 might include infrastructure as a service (IaaS), software as a service (SaaS), and platform as a service (PaaS). In some instances, a supplier 120 might be a hyperscaler (e.g., Amazon Web Services (AWS), Google Cloud Platform (GCP), etc.).

The historical information received from suppliers 120 might include operating specifications for the one or more services supported and provided by each specific supplier. In some embodiments, the historical information might include a cost associated with the service(s) offered by the supplier, an availability of the services(s) offered by the supplier (e.g., 24×7 uptime), security features offered by the supplier (including but not limited to compliance with one or more security regulations, laws, policies, etc.), support model(s) offered by the supplier, location availability for the service(s) offered by the supplier, and other quantifiable aspects (i.e., metrics) related to services offered by the supplier.

In some embodiments, the historical information might be received from suppliers 120 via a direct communication link to the cloud providers (i.e., suppliers 120). The direct link to the suppliers may facilitate an updating of the historical information received by and maintained in supplier database 115. In some embodiments, the historical information received by and maintained in supplier database 115 might be automatically updated, at least periodically, by the retrieval of “current” cloud service specification values.

The historical information received by and maintained in supplier database 115 may be accessed and used by trend analytics system 125 to generate trends regarding the cloud service(s) represented in the historical information. In some aspects, the trends generated by trend analytics system 125 based on the historical information from supplier database 115 might include a historical trend component and a predictive trend component. In some embodiments, the historical trend component provides a representation of past (i.e., actual) data points for an attribute of a cloud service, whereas the predictive trend component of the generated trend provides a representation of predicted (i.e., future) data points for an attribute of a cloud service based on an analysis of the historical information received by and maintained in supplier database 115. Trend analytics system 125 might generate dynamic trends based on historical data-based predictive analytics for each cloud service that matches input value parameters, for example, determining that reliability of a service steadily increased over several periods (e.g., 3-month periods of time). In some embodiments, the historical information received by and maintained in supplier database 115 comprises time series data. Trend analytics system 125 might use data mining of the time series data and one or more modeling engines to model the entire time series into a trend including a past trend component and a predictive trend component, where the modeling engine generates predicted data points in the predictive trend based on the historical information received by and maintained in supplier database 115.

In some embodiments, one or several modeling techniques might be used by trend analytics system 125 to generate the trends for cloud services herein. In some embodiments, trend analytics system 125 might use analytical/statistical packages to analyze historical trend data (e.g., Python has libraries such as NumPy (https://numpy.org/), Pandas (https://pandas.pydata.org), etc.).

Unless otherwise stated, the modeling techniques that may be used to generate the trends for cloud services herein are not limited to any particular modeling technique or process if otherwise applicable and compatible with other aspects herein.

Referring still to FIG. 1, cloud service recommendation system 105 includes a recommendation engine 130 that receives, as inputs thereto, the trends generated by trend analytics system 125 and user input parameters processed by input processing module 110. In some embodiments, input processing module 110 might process usage-related information received from user 150 that includes one or more values for usage-related parameters for a cloud service to, for example, configure the user supplied data into a format and configuration that is compatible with the data requirements of recommendation engine 130. For example, in some instances the usage-related information received from the user might be processed by input processing module 110 into a set of weighted input parameter values, in accordance with one or more rules and processes of input processing module 110, recommendation engine 130, and other aspects of client service recommendation system 105 (e.g., a user might indicate they place a greater importance on a cost for a service as compared to backup services for a cloud service; input processing module 110 and rules implemented thereby might place, by default, a greater importance on cloud-service availability as compared to a RAM size for a particular cloud service, etc.). For example, cloud service recommendation system 105 system might receive weighted value parameters representing customer needs, such as reliability, performance, functionality, etc.

Cloud service recommendation system 105 may generate a recommendation for a cloud service that “best” corresponds to a user's input parameters for a current use and a future use by the user. For context, recommendation engine 130 might use one or several modeling techniques to generate a “best” possible recommendation for a cloud service. Recommendation engine 130 may further compare the trends generated by trend analytics system 125 using each of the different modeling techniques and (automatically) determine the “best” recommendation that best corresponds to the values for the set of usage-related parameters for the one or more cloud services received from the user. A recommendation determined by recommendation engine 130 may be provided to user 150. The recommendation output by the recommendation engine may be provided to the user via a graphical user interface of , for example, a browser that the user can access to provide input(s) to and receive output(s) from cloud service recommendation system 105. The recommendations from recommendation engine 130 may be stored in a database (e.g., configuration database 135 for possible further processing and record keeping) or other data storage device or service.

In some embodiments, the trends are evaluated by recommendation engine 130 to determine the best cloud service for the specific customer using weights of input parameters, that does not exceed the maximum value of available cloud tokens from the customer.

In some embodiments, cloud service recommendation system 105 might include a configuration database 135 that contains previous user-specified cloud service requirement set(s) and possibly sample (e.g., hypothetical “best practices” or “model”) requirement sets and an associated recommended cloud service for each of these cloud service requirement sets. In some embodiments, the requirement sets stored in configuration database may contain, similar to values for input parameters provided by user 150, a singular value (for example, RAM size) or multiple values (e.g., average, highest 5%, lowest 5%, etc.) for each parameter. In some embodiments, a “similarity” might be determined, for example, by referencing a lookup table that lists an attribute name and a corresponding rule. For example, a rule might specify no more than plus-minus 10% for RAM size. In some instances, an applicable rule can be based on multiple attributes (e.g., if the RAM size is less than asked by more than 5%, the computing power should be more than requested by at least 10%). In this manner, a level of efficiency may be gained by some embodiments by not progressing through a full recommendation determination process, wherein a saved (e.g., cached) recommendation can be immediately given to the user.

In some embodiments, a maximum amount of payment tokens (or other forms of a payment currency or credit) that the user is willing to pay for one or more cloud services might be (e.g., either selectively or by a default setting or rule) an overall constraining factor in a “best” cloud service recommendation generated by a cloud service recommendation system herein. That is, in some embodiments a maximum amount of payment tokens (or other forms of a payment currency or credit) specified by the user (e.g., as part of the input parameter values) can be used in determining the recommendation of the “best” choice for one or more subject cloud services for the given user. For example, the trend(s) may be evaluated by recommendation engine 130 to determine the best cloud service for the specific user (e.g., customer) using weights of the input parameters, that do not exceed the maximum value of the payment tokens (or other forms of a payment currency or credit) available from or specified by the user.

In some instances, in determining a recommendation for a cloud service for a user, input processing module 110 may (optionally, as indicated by the dashed line between input processing module 110 and configuration database 135) search configuration database 135 for a similar or close match that satisfies user-specified requirements. If a match with the user-specified cloud service requirements is found in configuration database 135, then the recommendation saved with the stored configuration may be recommended to the user. Absent a match with the user-specified cloud service requirements in configuration database 135, the trend(s) generated by trend analytics system 125 may be used by recommendation engine 130 to generate the recommendation for the user.

In some embodiments, user-specified information regarding a cloud service might include public sentiment and/or reviews of cloud services. The public sentiment and/or reviews of cloud services might be based on the collection and analysis of public sentiment/reviews of cloud services on the Internet, for example, using semantic rules, and further using the public sentiment and/or reviews of cloud services as an additional factor in the determination of a “best” cloud service. In some embodiments, the collection and analysis of public sentiment/reviews of cloud services might be performed by a user 150 or a third-party service or entity (not shown in figures). In some embodiments, the use and consideration of public sentiment/reviews of cloud services in the determination of a recommendation by cloud service recommendation system 105 might be optional, selectively invoked, or used in the instance the “best” choice of a recommended cloud service is closely contested between at least two cloud services.

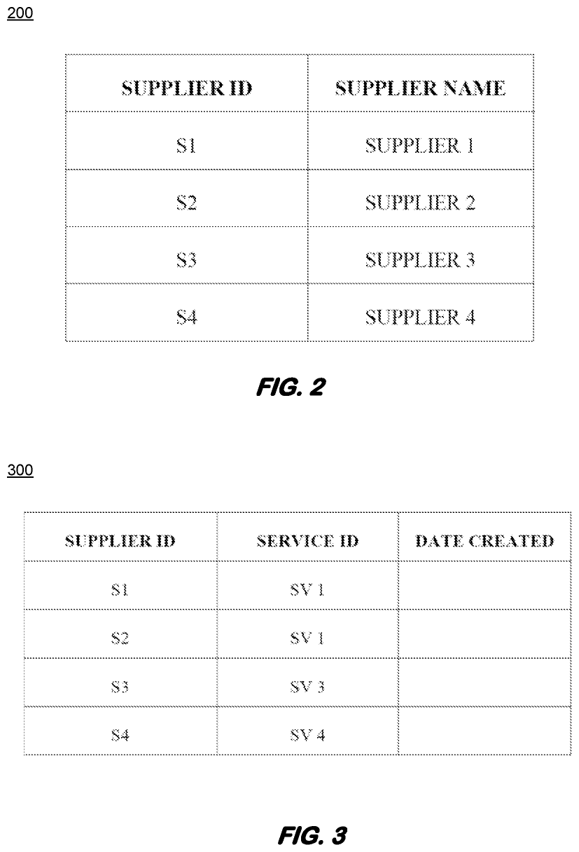

FIG. 2 is an illustrative depiction of a table associated with a cloud service recommendation system, according to some embodiments. Table 200 represents, in some aspects, a simplified table representation for data including cloud providers (i.e., suppliers) that might provide data to a cloud service recommendation system, in accordance with other aspects disclosed herein. At a minimum in some aspects, table 200 includes a supplier identifier (Supplier ID) and the corresponding name for the supplier. In some embodiments, other supplier related information might be included in data relate to suppliers herein and table 200 (or other table representations of that data) may be modified to also reflect the additional or other supplier related data. The supplier ID may be unique to each associated supplier.

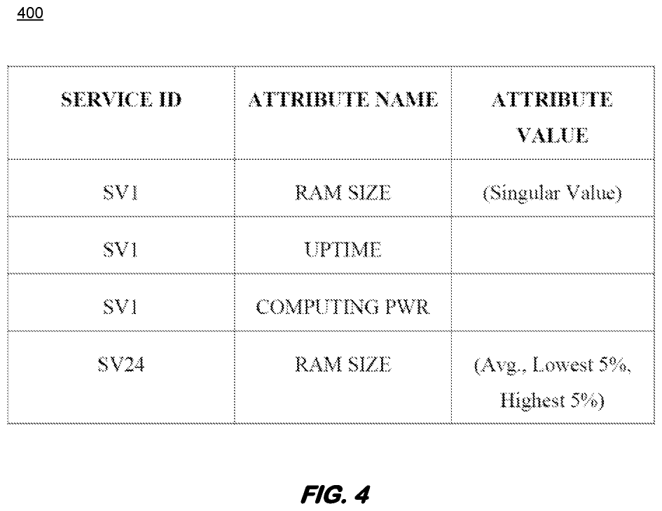

FIG. 3 is an illustrative depiction of a table for cloud services, according to some embodiments. Table 300 represents, in some aspects, a simplified table representation for data including cloud services provided or offered by different suppliers, in accordance with other aspects disclosed herein. At a minimum in some aspects, table 300 includes a supplier identifier (Supplier ID as specified in table 200) and the corresponding services provided or offered by the indicated supplier(s). Table 300 also includes a column for the date each service was created. In some embodiments, other service-related information might be included in data relate to suppliers herein and table 300 (or other table representations of that data) may be modified to also reflect the additional or other service related data. In some aspects, one or more service identifiers (Service ID) may be associated with a particular supplier ID since a given supplier might provide one or more services of interest to a user.

FIG. 4 is an illustrative depiction of a table for cloud service attributes, according to some embodiments. Table 400 represents, in some aspects, minimum aspects of a table representation for data including attributes for cloud services provided or offered by different suppliers, in accordance with other aspects disclosed herein. In some aspects, table 400 includes a service identifier (Service ID as specified in table 300), an attribute name for an attribute (i.e., parameter) associated with the identified service, and a value associated with the given attribute. Table 400, in some embodiments, might include other attribute-related information based on the types of services and attributes thereof. In some aspects, one or more attributes (Attribute Name) may be associated with a particular service ID since a given service might be represented or associated with multiple attributes.

In some embodiments, no customer-specific information may be stored in one or more (e.g., all) database tables associated with an embodiment herein to, for example, protect the privacy of users (e.g., customers), commercial trade secrets, and compliance with applicable rules, laws, regulations, industry practices, supplier policies, etc.

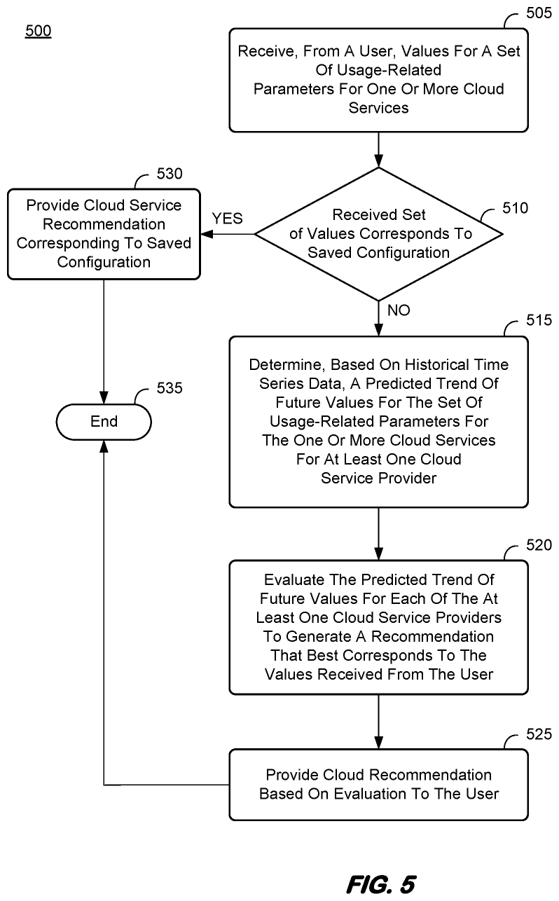

FIG. 5 is a process 500 that might be performed by some or all of the elements of an embodiment described herein. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein. Some aspects of process 500 have been disclosed in the discussion of FIG. 1 and can be further understood by a reference thereto.

Operation 505 includes receiving values from a set of usage-related parameters from one or more cloud services from a user. The parameter values might be received manually from a user via a graphical (or other type of) user interface. In some embodiments, the parameter values might be automatically received from a system, application, or device associated with the user where, for example, an agent program monitors a current configuration (e.g., processing metrics, system location, etc.) and transmits values for these parameters to the cloud service recommendation system (e.g., input processing system 105 in FIG. 1). In some aspects, the usage-related parameters relate to quantifiable metrics related to a cloud service. In some embodiments, the usage-related parameters might include public sentiment and reviews (or other semantics) that might be rendered into a relative, quantifiable representation.

At operation 510, a determination is made whether the received set of values corresponds to a saved set of configuration values, where each saved set of configuration values is associated with a particular cloud service recommendation. In the event the set of values received at operation 510 corresponds to a saved set of configuration values, then process 500 may proceed to operation 530 where the recommendation associated with the saved configuration set matching the received values is provided to the user. In some embodiments, process 500 terminates at 535 after the recommendation is provided to the user at operation 530.

In the instance the set of values received at operation 510 does not correspond to a saved set of configuration values, then process 500 may proceed to operation 515 where a predicted trend of future values for the set of usage-related parameters for the one or more cloud services is determined or generated (by, for example, trend analytics system 125 of FIG. 1) for at least one service provider. The trend(s) generated at operation 515 may capture the changes in the behavior of an attribute of a cloud service (e.g., availability, reliability, etc.) over an extended period of time. In some embodiments, an extended amount of time might vary depending on a particular cloud service and technology associated therewith. In some embodiments, a trend might provide predicted data values for at least one future three (3) month period of time.

At operation 520, an evaluation of the predicted trend(s) of future values for the set of usage-related parameters for the one or more cloud services for each of the at least one cloud service providers is executed to generate a recommendation that “best” corresponds to the values for the set of usage-related parameters for the one or more cloud services received from the user. In some embodiments (see FIG. 1), operation 515 might be implemented by a recommendation engine 130 that receives input(s) from an input processing module 110 and trend data based on an analysis of historical cloud service related data from trend analytics system 125, where the recommendation engine processes these data to determine a “best” cloud service recommendation for a particular user. For example, if a first configuration of a cloud serviced meets the current needs of a user and generated trend data indicates a majority of similarly situated users eventually migrate to a second configuration of the cloud service after, for example, two(2) years, then an optimal (i.e., “best”) solution for the customer may be to recommend the second configuration of the cloud service to the user to satisfy both their current needs and their future needs.

Continuing to operation 525, the recommendation generated at operation 520 may be provided to the user. The recommendation might also be stored for further processing and use in a data storage device or by a database service. In some embodiments, process 500 terminates at 535 after the recommendation is provided to the user at operation 525.

In some embodiments, a “match” between parameter values might consider and include values within a specified threshold of each other. For example, if a model configuration for a cloud service has 256 Gb of memory and a user specifies 264 Gb for the cloud service, then this particular cloud service configuration may still be a valid option as a “best” recommendation since it might be within a specified threshold (e.g., specified value±5%).

In some embodiments, a process (e.g., separate from process 500 or included therein) may include processing (e.g., data mining) cached recommendations during a maintenance period to ensure that the stored recommendations are up-to-date, while purging those that are out-of-date. In some embodiments, a process herein might include creating new model set(s) based on an analysis of user requests (e.g., if one or more users have requested cloud services that provide 99.99% and 99.9999% uptime, then one process herein might create a model for 99.999% uptime).

In some aspects, some embodiments disclosed herein use trend analysis to determine how well user-specified requirements are predicted to change in the future and use such information to make a recommendation of a cloud service based on that trend prediction. That is, some embodiments herein provide a mechanism to meet data-driven, predicted requirements for a user (i.e., not merely querying a database for a service that meets current requirements).

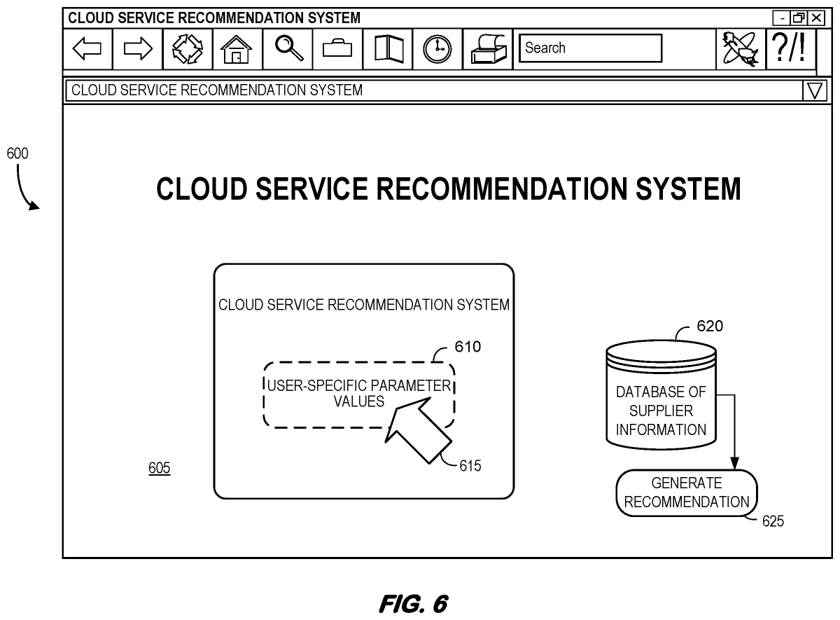

FIG. 6 is an outward facing user interface related to a system and process for a cloud service recommendation, according to some embodiments. FIG. 6 is a human-machine interface display 600 in accordance with some embodiments. The display 600 includes a graphical representation 605 or dashboard that might be used to interact with a cloud service recommendation system to provide inputs thereto and receive outputs therefrom. In particular, selection of an element (e.g., a user-specific parameter values entry button 610 using computer mouse pointer 615) might result in the display of a popup window (not shown) that accepts entry of values for cloud service parameters from a user (i.e., the user's requirements for the cloud service). Display 600 also includes a representation of a database of supplier information 620. Display 600 includes a user selectable “Generate Recommendation” icon 625 to request a “best” cloud service for the user that is determined based on the use-specified inputs to the system and trend analysis of the database of supplier information.

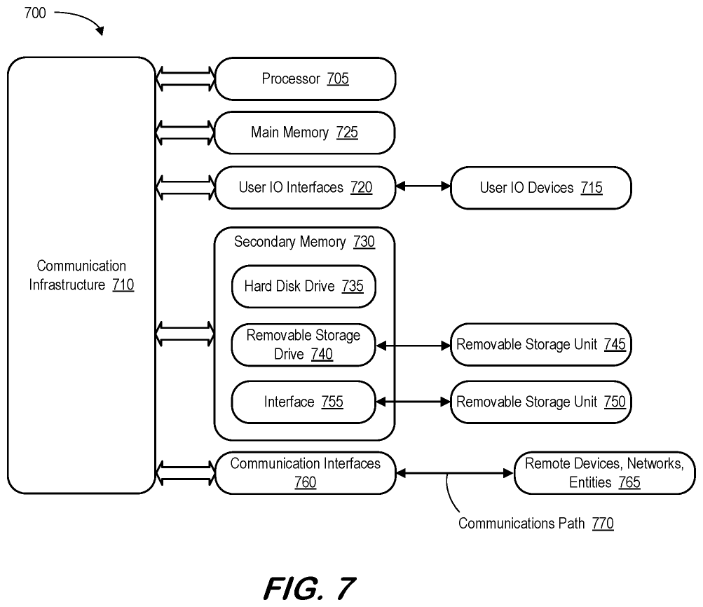

Various embodiments can be implemented, for example, using one or more well-known computer systems, such as computer system 700 shown in FIG. 7. The computer system 700 can be any well-known computer capable of performing the functions described herein. Computer system 700 includes one or more processors (also called CPUs), such as a processor 705. Processor 705 is connected to a communication infrastructure or bus 710.

One or more processors 705 may each be a Graphics Processing Unit (“GPU”). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 715, such as monitors, keyboards, pointing devices, etc., that communicate with communication infrastructure xx06 through user input/output interface(s) 720.

Computer system 700 also includes a main or primary memory 725, such as Random-Access Memory (“RAM”). Main memory 725 may include one or more levels of cache. Main memory 725 has stored therein control logic (i.e., computer software) and/or data.

Computer system 700 may also include one or more secondary storage devices or memory 730. Secondary memory 730 may include, for example, a hard disk drive 735 and/or a removable storage device or drive 740. Removable storage drive 740 may be a floppy disk drive, a magnetic tape drive, a compact disk drive, an optical storage device, tape backup device, and/or any other storage device/drive.

Removable storage drive 740 may interact with a removable storage unit 745. Removable storage unit 745 includes a computer usable or readable storage device having stored thereon computer software (control logic) and/or data. Removable storage unit 745 may be a floppy disk, magnetic tape, compact disk, DVD, optical storage disk, and/any other computer data storage device. Removable storage drive 740 reads from and/or writes to removable storage unit 745 in a well-known manner.

According to an exemplary embodiment, secondary memory 730 may include other means, instrumentalities or other approaches for allowing computer programs and/or other instructions and/or data to be accessed by computer system 700. Such means, instrumentalities or other approaches may include, for example, a removable storage unit 750 and an interface 755. Examples of the removable storage unit 750 and the interface 755 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 760. Communication interface 760 enables computer system 700 to communicate and interact with any combination of remote devices, remote networks, remote entities, etc. (individually and collectively referenced by reference number 765). For example, communication interface 760may allow computer system 700 to communicate with remote devices 765 over communications path 770, which may be wired and/or wireless, and which may include any combination of LANs, WANs, the Internet, etc. Control logic and/or data may be transmitted to and from computer system 700 via communication path 770.

In an embodiment, a tangible apparatus or article of manufacture comprising a tangible computer useable or readable medium having control logic (software) stored thereon is also referred to herein as a computer program product or program storage device. This includes, but is not limited to, computer system 700, main memory 725, secondary memory 730, and removable storage units 745 and 750, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 7. In particular, embodiments may operate with software, hardware, and/or operating system implementations other than those described herein.

Although specific hardware and data configurations have been described herein, note that any number of other configurations may be provided in accordance with some embodiments of the present invention (e.g., some of the information associated with the databases and storage elements described herein may be combined or stored in external systems). Moreover, although some embodiments are focused on particular types of applications and services, any of the embodiments described herein could be applied to other types of applications and services. In addition, the displays shown herein are provided only as examples, and any other type of user interface could be implemented.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims

Various embodiments can be implemented, for example, using one or more well-known computer systems, such as computer system 700 shown in FIG. 7. The computer system 700 can be any well-known computer capable of performing the functions described herein. Computer system 700 includes one or more processors (also called CPUs), such as a processor 705. Processor 705 is connected to a communication infrastructure or bus 710.

One or more processors 705 may each be a Graphics Processing Unit (“GPU”). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 715, such as monitors, keyboards, pointing devices, etc., that communicate with communication infrastructure xx06 through user input/output interface(s) 720.

Computer system 700 also includes a main or primary memory 725, such as Random-Access Memory (“RAM”). Main memory 725 may include one or more levels of cache. Main memory 725 has stored therein control logic (i.e., computer software) and/or data.

Computer system 700 may also include one or more secondary storage devices or memory 730. Secondary memory 730 may include, for example, a hard disk drive 735 and/or a removable storage device or drive 740. Removable storage drive 740 may be a floppy disk drive, a magnetic tape drive, a compact disk drive, an optical storage device, tape backup device, and/or any other storage device/drive.

Removable storage drive 740 may interact with a removable storage unit 745. Removable storage unit 745 includes a computer usable or readable storage device having stored thereon computer software (control logic) and/or data. Removable storage unit 745 may be a floppy disk, magnetic tape, compact disk, DVD, optical storage disk, and/any other computer data storage device. Removable storage drive 740 reads from and/or writes to removable storage unit 745 in a well-known manner.

According to an exemplary embodiment, secondary memory 730 may include other means, instrumentalities or other approaches for allowing computer programs and/or other instructions and/or data to be accessed by computer system 700. Such means, instrumentalities or other approaches may include, for example, a removable storage unit 750 and an interface 755. Examples of the removable storage unit 750 and the interface 755 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 760. Communication interface 760 enables computer system 700 to communicate and interact with any combination of remote devices, remote networks, remote entities, etc. (individually and collectively referenced by reference number 765). For example, communication interface 760may allow computer system 700 to communicate with remote devices 765 over communications path 770, which may be wired and/or wireless, and which may include any combination of LANs, WANs, the Internet, etc. Control logic and/or data may be transmitted to and from computer system 700 via communication path 770.

In an embodiment, a tangible apparatus or article of manufacture comprising a tangible computer useable or readable medium having control logic (software) stored thereon is also referred to herein as a computer program product or program storage device. This includes, but is not limited to, computer system 700, main memory 725, secondary memory 730, and removable storage units 745 and 750, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 7. In particular, embodiments may operate with software, hardware, and/or operating system implementations other than those described herein.

Although specific hardware and data configurations have been described herein, note that any number of other configurations may be provided in accordance with some embodiments of the present invention (e.g., some of the information associated with the databases and storage elements described herein may be combined or stored in external systems). Moreover, although some embodiments are focused on particular types of applications and services, any of the embodiments described herein could be applied to other types of applications and services. In addition, the displays shown herein are provided only as examples, and any other type of user interface could be implemented.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system comprising:
a memory storing processor-executable program code; and
a processing unit to execute the processor-executable program code to cause the system to:
receive, from a user, values for a set of usage-related parameters for one or more cloud services;
determine, based on historical time series data for the one or more services provided by at least one cloud service provider, a predicted trend of future values for the set of usage-related parameters for the one or more cloud services for the at least one cloud service provider;
evaluate the predicted trend of future values for the set of usage-related parameters for the one or more cloud services for each of the at least one cloud service providers to generate a recommendation that best corresponds, at least within a specified threshold, to the values for the set of usage-related parameters received from the user; and
store an indication of the generated recommendation in a data storage device.

2. The system of claim 1, wherein the set of usage-related parameters includes at least one of a reliability parameter, a region availability parameter, a download/upload speed parameter, a bandwidth parameter, and a security parameter.

3. The system of claim 1, wherein the values for the set of usage-related parameters for one or more cloud services are automatically received via an interface with an operable configuration of a cloud service of the user.

4. The system of claim 1, wherein the historical time series data for the one or more services provided by at least one cloud service provider is received directly from the at least one cloud service provider.

5. The system of claim 1, wherein the predicted trend of future values for the set of usage-related parameters for the one or more cloud services for the at least one cloud service provider includes predicted values for a future time period of at least three months.

6. The system of claim 1, further comprising:
determining whether the values for the set of usage-related parameters for one or more cloud services received from the user corresponds, at least within a specified threshold, with to a stored record of a set of usage-related parameters for the one or more cloud services; and
in an instance the values for the set of usage-related parameters for one or more cloud services received from the user corresponds to the stored record, provide a recommendation associated with the stored record to the user.

7. The system of claim 1, wherein customer-specific information is not used in the determination of the predicted trend of future values and the evaluation of the predicted trend of future values to generate the recommendation.

8. A computer-implemented method, the method comprising:
receiving, from a user, values for a set of usage-related parameters for one or more cloud services;
determining, based on historical time series data for the one or more services provided by at least one cloud service provider, a predicted trend of future values for the set of usage-related parameters for the one or more cloud services for the at least one cloud service provider;
evaluating the predicted trend of future values for the set of usage-related parameters for the one or more cloud services for each of the at least one cloud service providers to generate a recommendation that best corresponds, at least within a specified threshold, to the values for the set of usage-related parameters received from the user; and
storing an indication of the generated recommendation in a data storage device.

9. The method of claim 8, wherein the set of usage-related parameters includes at least one of a reliability parameter, a region availability parameter, a download/upload speed parameter, a bandwidth parameter, and a security parameter.

10. The method of claim 8, wherein the values for the set of usage-related parameters for one or more cloud services are automatically received via an interface with an operable configuration of a cloud service of the user.

11. The method of claim 8, wherein the historical time series data for the one or more services provided by at least one cloud service provider is received directly from the at least one cloud service provider.

12. The method of claim 8, wherein the predicted trend of future values for the set of usage-related parameters for the one or more cloud services for the at least one cloud service provider includes predicted values for a future time period of at least three months.

13. The method of claim 8, further comprising:
determining whether the values for the set of usage-related parameters for one or more cloud services received from the user corresponds, at least within a specified threshold, to a stored record of a set of usage-related parameters for the one or more cloud services; and
in an instance the values for the set of usage-related parameters for one or more cloud services received from the user corresponds to the stored record, provide a recommendation associated with the stored record to the user.

14. The method of claim 8, wherein customer-specific information is not used in the determination of the predicted trend of future values and the evaluation of the predicted trend of future values to generate the recommendation.

15. A non-transient, computer-readable medium storing instructions to be executed by a processor to perform a method, the method comprising:
receiving, from a user, values for a set of usage-related parameters for one or more cloud services;
determining, based on historical time series data for the one or more services provided by at least one cloud service provider, a predicted trend of future values for the set of usage-related parameters for the one or more cloud services for the at least one cloud service provider;
evaluating the predicted trend of future values for the set of usage-related parameters for the one or more cloud services for each of the at least one cloud service providers to generate a recommendation that best corresponds, at least within a specified threshold, to the values for the set of usage-related parameters received from the user; and
storing an indication of the generated recommendation in a data storage device.

16. The medium of claim 15, wherein the set of usage-related parameters includes at least one of a reliability parameter, a region availability parameter, a download/upload speed parameter, a bandwidth parameter, and a security parameter.

17. The medium of claim 15, wherein the values for the set of usage-related parameters for one or more cloud services are automatically received via an interface with an operable configuration of a cloud service of the user.

18. The medium of claim 15, wherein the historical time series data for the one or more services provided by at least one cloud service provider is received directly from the at least one cloud service provider.

19. The medium of claim 15, wherein the predicted trend of future values for the set of usage-related parameters for the one or more cloud services for the at least one cloud service provider includes predicted values for a future time period of at least three months.

20. The medium of claim 15, further comprising:
determining whether the values for the set of usage-related parameters for one or more cloud services received from the user corresponds, at least within a specified threshold, to a stored record of a set of usage-related parameters for the one or more cloud services; and
in an instance the values for the set of usage-related parameters for one or more cloud services received from the user corresponds to the stored record, provide a recommendation associated with the stored record to the user.
